(19) United States
(12) Patent Application Publication
(10) Pub. No.: US 2024/0117639 A1
(43) Pub. Date: Apr. 11, 2024

(54) LOCKING APPARATUS AND SYSTEM

(71) Applicant: Barrette Outdoor Living, Inc., Middleburg Heights, OH (US)

(72) Inventors: Christopher Michael Schneider, Linwood, NJ (US); Paige Barbara Moore, Absecon, NJ (US); Patrick Joseph Bertke, Mays Landing, NJ (US)

(21) Appl. No.: 17/960,220

(22) Filed: Oct. 5, 2022

(51) Int. Cl. E04F 13/08

(52) U.S. Cl. CPC E04F 13/0841

(57) ABSTRACT

A system includes one or more decorative screen panels configured at an initial position. The system also includes a locking and spacing apparatus positioned on an exterior portion of the one or more decorative screen panels. The spacer is positioned to receive a locking mechanism. The locking mechanism is positioned on the locking and spacing apparatus over the one or more decorative screen panels. A first portion of the locking mechanism is positioned within the spacer. A second portion of the locking mechanism is positioned under the locking and spacing apparatus and configured to move in a perpendicular direction. The movement in the perpendicular direction secures the locking mechanism within the locking and spacing apparatus.

### FIELD OF INVENTION

Embodiments of the present invention generally relate to locking system to secure a decorative screen panel onto an interconnected structure.

### BACKGROUND

Typical locking mechanisms within interconnected structures can often be inefficient. A measure of the typical inefficiency can be that the locking mechanism will be very cumbersome to execute. The locking mechanism can take a large amount of space. As a result, the aesthetic appeal of the interconnected structure will be reduced due to the appearance of the locking mechanism.

The efficiency in which the locking mechanism can be locked often makes such a locking mechanism difficult to apply within an interconnected structure. In many instances, one or keys are required to lock and unlock the unlocking mechanism within the interconnected structure.

The amount of space in which the locking mechanism takes can often make it tedious to place the locking mechanism onto the desired position. Many locking mechanism can be very bulky, and have to be placed on a greater portion of the panel to be locked in place that what is desired.

Another issue with many locking mechanisms is being unable to securely fasten the panel or device on which the locking mechanism is secured. When one or more unforeseen events occur, the panel or device can lose its position and not be secured within its position by the locking mechanism.

Accordingly, a need exits for a locking mechanism that is easy to assemble and which does not take up as much space in the desired position. Further, a need exists for locking mechanism to securely hold in placed the panel or object at the desired position. Further, the locking mechanism should be able to hold the panel and/or object in place when one or more unforeseen circumstances occur which apply unexpected force or pressure on the panel and/or object.

### SUMMARY

Embodiments in accordance with the present invention provide system, wherein one or more decorative screen panels are configured at an initial position. The system also includes a locking and spacing apparatus positioned on an exterior portion of the one or more decorative screen panels, wherein a spacer within the locking and spacing apparatus is positioned to receive a locking mechanism. The system also includes the locking mechanism positioned on the locking and spacing apparatus over the one or more decorative screen panels. A first portion of the locking mechanism is positioned within the spacer of the locking and spacing apparatus. A second portion of the locking mechanism is positioned under the locking and spacing apparatus and configured to move in a perpendicular direction. The second portion's movement in the perpendicular direction secures the locking mechanism within the locking and spacing apparatus.

The spacer is positioned in a center portion of the locking and spacing apparatus.

The first portion of the locking mechanism is positioned within the spacer and over an exterior portion of the one or more decorative screen panels.

In an embodiment of the present invention, a system includes a decorative screen panel configured at an initial position. The system also includes a spacer configured onto the decorative screen panel, wherein the spacer is configured on an exterior portion of the decorative screen panel, wherein a center portion of the spacer includes an opening for one or more devices. The system also includes a camlock device positioned on the spacer on the exterior portion of the decorative screen panel. A first portion of the camlock device is positioned within the spacer. A second portion of the camlock device is positioned under the spacer. The first and second portions of the camlock device are rotated to secure the spacer onto the decorative screen panel.

The first portion of the camlock device is rotated in a perpendicular direction to secure the spacer onto the decorative screen panel.

The second portion of the camlock device is rotated in a same direction as the first portion of the camlock device to secure the camlock device over the decorative screen panel.

According to another embodiment of the present invention, a method includes configuring one or more decorative screen panels cat an initial position. The method also includes positioning a locking and spacing apparatus on an exterior portion of the one or more decorative screen panels, wherein a spacer within the locking and spacing apparatus is positioned to receive a locking mechanism. The method also includes configuring the locking mechanism on the locking and spacing apparatus over the one or more decorative screen panels. A first portion of the locking mechanism is positioned within the spacer of the locking and spacing apparatus. A second portion of the locking mechanism is positioned under the locking and spacing apparatus and configured to move in a perpendicular direction. The second portion's movement in the perpendicular direction secures the locking mechanism within the locking and spacing apparatus.

The method also includes rotating the first portion of the locking mechanism in the perpendicular direction in alignment with the second portion of the locking mechanism.

The method also includes positioning the first portion of the locking mechanism over the spacer to secure the locking and spacing apparatus.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1 illustrates a view of a portion of the twist and lock system;

FIG. 2 illustrates another aspect of the twist and lock system;

FIG. 3 illustrates a further aspect of the twist and lock system;

FIG. 4 illustrates an application of the twist and lock system; and

FIG. 5 illustrates a flow chart of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

An interconnected structure that is used to entertain guests or users at outdoor venues will often have decorative screen panels that placed at the top and/or side portions of the interconnected structure. The interconnected structure, in one or more embodiments, can include frame members, mid-beams, center beams, corner brackets, and corner posts. The interconnected structure can have a plurality of the decorative screen panels positioned adjacent to each other in the top and/or side portion of the interconnected structure. A combination of a camlock device and locking and spacing apparatus can secure the decorative screen panels within the interconnected structure.

The locking and spacing apparatus can have a spacer in a center region with a circular or round opening. The spacer of the locking and spacing apparatus can be configured to receive a portion of the camlock device to secure the decorative screen panels in place. The locking and spacing apparatus can have the camlock device positioned partly above, within, and below the locking and spacing apparatus.

The camlock device can include a first and second portion. A first portion of the camlock device can be positioned within and over the locking and spacing apparatus. Part of the first portion will be positioned within the spacer of the locking and spacing apparatus. Further, another part of the first portion will be positioned over the spacer. The second portion of the camlock device can be positioned underneath the locking and spacing apparatus. The length and width of the first portion of camlock device will be greater than the length and width of the second portion of the camlock device. When both the first and second portions of the camlock device are positioned above, within, and underneath the locking and spacing apparatus respectively, the camlock device can then secure the locking and spacing apparatus within the decorative screen panel. As such, the decorative screen panel can be held secure when force is applied or unforeseen circumstances occur.

The first and second portions of the camlock device can be aligned with each other when in their respective positions within, above, and underneath the locking and spacing apparatus. Both the first and second portions of the camlock device can be rotated perpendicularly to secure the locking and spacing apparatus within the respective decorative screen panel. Further, when both the first and second portions of the camlock device are fully rotated in the perpendicular direction, the locking and spacing apparatus will be secured within the decorative screen panel.

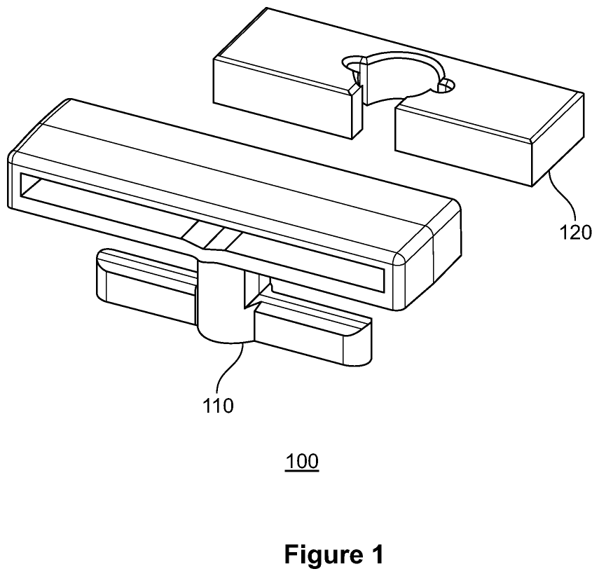

In FIG. 1, a system 100 is illustrated with two sets of devices that can be used in conjunction to provide a secure locking mechanism for decorative screen panels in an inter-connected structure such as a T-Bar bracket structure. A camlock device 110 is shown. The camlock device 110 can have a top portion and a bottom portion that will be used to secure a decorative screen panel in the interconnected structure. The bottom portion can be positioned in contact with a portion of the decorative screen panel and underneath another locking device. The top portion of the camlock device 110 can be positioned over the decorative screen panel and also over the bottom portion of the camlock device 110 and the other locking mechanism. When the camlock device 110 is set in its locking position, the both the top portion and bottom portion of the camlock device 110 are fully rotated in the perpendicular direction.

Referring to FIG. 1, a locking and spacing apparatus 120 is also shown. The locking and spacing apparatus 120 will work in conjunction with the camlock device 110 to secure a decorative screen panel securely in place within an interconnected T-bracket structure. The locking and spacing apparatus 120 includes a spacer in a center region of the locking and spacing apparatus 120. The spacer can include a circular or round opening within the center region of the locking and spacing apparatus 120. The spacer is configured to receive the bottom portion of the camlock device 110. The bottom portion of the camlock device 110 is placed within the spacer of the locking and spacing apparatus 120. The bottom portion of the camlock device 110 will be directly below the top portion of the camlock device 110 when the bottom portion of the camlock device 110 is inserted within the spacer of the locking and spacing apparatus 120.

Referring to FIG. 1, when the top portion of the camlock device 110 is positioned above the spacer and locking and spacing apparatus 120, the bottom portion of the camlock device 110 is positioned within the spacer and also underneath the spacer. The bottom and top portion of the camlock device 110 will be rotated in a perpendicular direction to secure the locking and spacing apparatus in place onto a decorative screen panel. Both the top and bottom portion of the camlock device 110 will be aligned and will rotate at the same angle to secure the locking and spacing apparatus 120 in its position within a decorative screen panel.

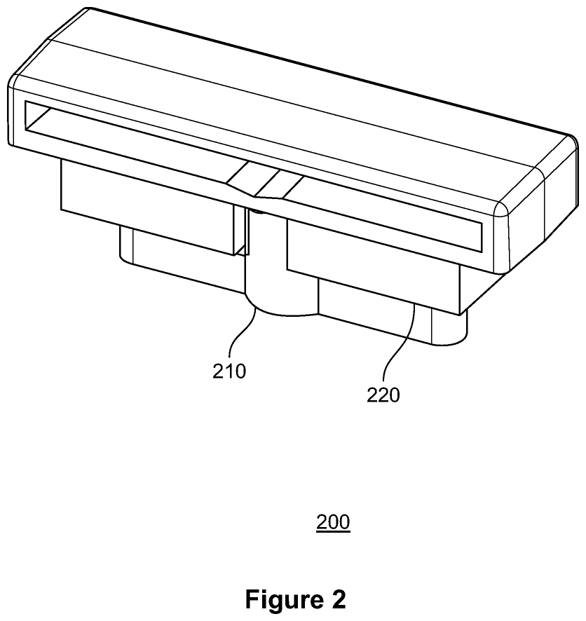

In FIG. 2, a system 200 is shown with a camlock device 210 and locking and spacing apparatus 220. In this embodiment, the camlock device 210 is inserted within the locking and spacing apparatus 220 and also positioned above and below the locking and spacing apparatus 220.

Referring to FIG. 2, the system 200 with the locking and spacing apparatus 220 in an unlocked position. The bottom portion of the camlock device 210 is positioned within a spacer of the locking and spacing apparatus 220. The spacer of the locking and spacing apparatus 220 can be within a center region of the locking and spacing apparatus 220. The bottom portion of the camlock device 210 will be positioned within the spacer and also below the spacer. The bottom portion of the camlock device 210 will be aligned with the top portion of the camlock device 210. As such, before the locking and spacing apparatus 220 is secured onto one or more decorative screen panels within the system 200, the top and bottom portions of the camlock device 210 have to be in their respective positions.

In FIG. 2, the bottom portion of the camlock device 210 has to be inserted within the spacer and also be below the locking and spacing apparatus 220. The top portion of the camlock device 210 will be positioned above the locking and spacing apparatus 220. The length and width of the top portion of the camlock device 210 will be greater than the length and width of the top portion of the camlock device 210. The top and bottom portions of the camlock device 210 will also be aligned in its respective positions above, within and below the locking and spacing apparatus 220.

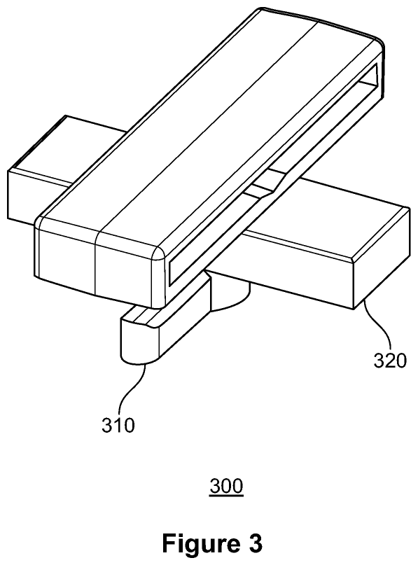

In FIG. 3, a system 300 is illustrated in which a locking and spacing apparatus is in a secured and locked position. The system 300 also illustrates the camlock device 310 and the locking and spacing apparatus 320. The locking and spacing apparatus 320, when positioned on an exterior frame of a decorative screen panel, must be secured and locked in place to enable the decorative screen panel to be secured and not fall out of place. As such, if the locking and spacing apparatus 320 is not secured in place, the decorative screen panel is likely to fall out of place when one or more unforeseen instances occur.

Referring to FIG. 3, the top and bottom portion of the camlock device 310 are rotated in the perpendicular direction to secure the locking and apparatus 320. When the bottom and top portions of the camlock device 310 are positioned in and around the locking and spacing apparatus 320, the top and bottom portions of the camlock device 310 are aligned. Both the top and bottom portions of the camlock device 310 are rotated perpendicularly to secure the locking and spacing apparatus 320 onto the decorative screen panel. Further, when the top and bottom portions of the camlock device 310 are each fully rotated in the perpendicular direction, the locking and spacing apparatus 320 is secured on the external frame of the decorative screen panel.

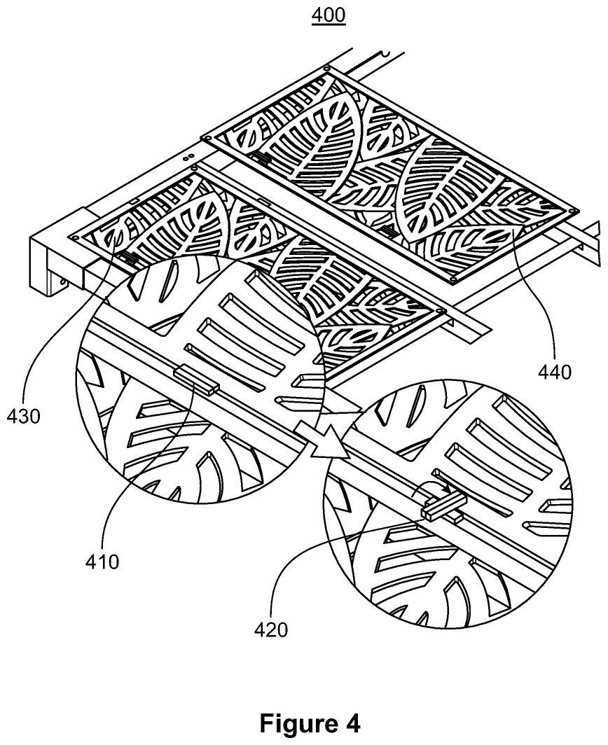

In FIG. 4, a system 400 is illustrated with a plurality of decorative screen panels 430, 440. Moreover, a locking and spacing apparatus 410 is positioned onto an exterior portion of the one or more of the decorative screen panels 430, 440. To secure at least one of the decorative screen panels 430, 440 in place, the locking and spacing apparatus 410 must be moved to a locking position.

Referring to FIG. 4, the locking and spacing apparatus 410 can be configured on the exterior portion of either of the decorative screen panels 430, 440. The locking and spacing apparatus 410 will first be positioned on the exterior of at least one of the decorative screen panels 430, 440. The locking and spacing apparatus 410 will also have a spacer within a center region of the locking and spacing apparatus 410 to receive a camlock device 420 that will lock and secure the locking and spacing apparatus 410 on the one or more decorative screen panels 430, 440. The camlock device 420 will include a bottom portion that will be positioned within and underneath the spacer of the locking and spacing apparatus 410. The camlock device 420 will also include a top portion that will be positioned above the locking and spacing apparatus 410.

In FIG. 4, the top and bottom portions of the camlock device 420 are rotated in the perpendicular direction to place the locking and spacing apparatus 410 in a locked position. As the top and bottom portions of the camlock device 420 are aligned above, within, and below the locking and spacing apparatus 410 respectively, both the top and bottom portions will rotate in the perpendicular direction. Further, when the top and bottom portions of the camlock device 420 are fully rotated in the perpendicular direction, the locking and spacing apparatus 410 will be secured on one or more of the decorative screen panels 430, 440. As a result, the one or more of the decorative screen panels 430, 440 will be securely held in place by the locking and spacing apparatus 410.

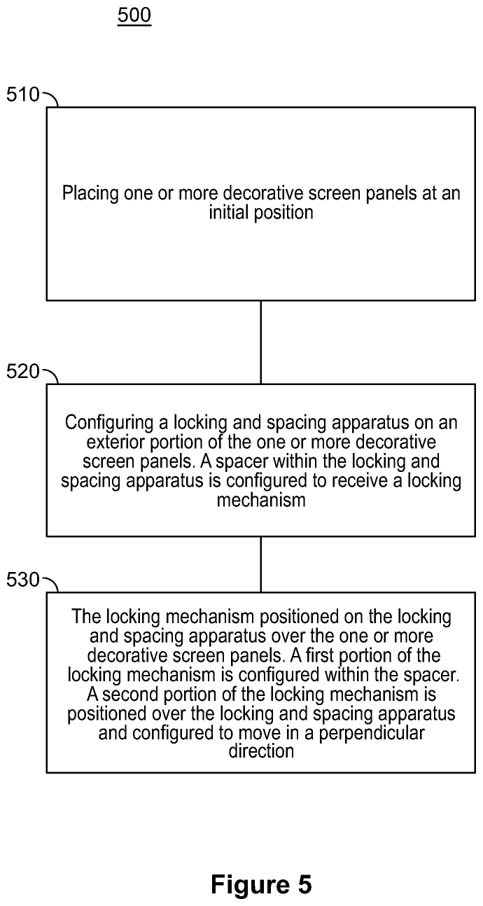

Referring to FIG. 5, a method 500 is illustrated of securing a locking and spacing apparatus on one or more decorative screen panels. Moreover, the method 500 also includes a locking mechanism that secure the locking and spacing apparatus onto the one or more decorative screen panels.

In FIG. 5, at step 510, one or more decorative screen panels will be placed in an initial position. The initial position can be a top portion of an interconnected structure that includes corner posts and corner brackets. The one or more decorative screen panels can be placed in between a plurality of frame members and corner brackets. In other embodiments, the one or more decorative screen panels can be on a side portion of the interconnected structure.

In FIG. 5, at step 520, a locking and spacing apparatus will be positioned on one or more decorative screen panels within an interconnected structure. The locking and spacing apparatus will include a spacer. The spacer will be positioned in a center region of the locking and spacing apparatus. The spacer will be configured to receive a locking mechanism to enable the locking and spacing apparatus to be secured onto the one or more decorative screen panels.

With respect to FIG. 5, at step 530, the locking mechanism is positioned on the locking and spacing apparatus over the one or more decorative screen panels. Moreover, a first portion of the locking mechanism is configured within the spacer. The first portion of the locking mechanism can also be positioned above the spacer as well. Further, a second portion of the locking mechanism is positioned under the locking and spacing apparatus. The first portion of the locking mechanism is configured to move in a perpendicular direction to lock the locking and spacing apparatus in place within the one or more decorative screen panels. The second portion of the locking mechanism is also aligned with the first portion of the locking mechanism. The second portion of the locking mechanism will also move in the perpendicular direction to lock the locking and spacing apparatus in place within the one or more decorative screen panels. When the first and second portion of the locking mechanism are fully rotated in the perpendicular direction, the locking and spacing apparatus will be secured onto the one or more decorative screen panels.

### Advantages/Summary

In summary, the locking and spacing apparatus can be positioned within an exterior portion of decorative screen panels. The decorative screen panels can be positioned at a top or side portion of an interconnected structure. A camlock device will be used to secure the locking and spacing apparatus on the decorative screen panels. Moreover, a first portion of the camlock device will be positioned within a spacer region within the locking and spacing apparatus. The spacer will be positioned within or near a center region of the locking and spacing apparatus. The first portion of the camlock device will also be positioned above the locking and spacing apparatus. The second portion of the camlock device will be placed underneath the spacer and will be aligned with the first portion of the camlock device. The length and width of the second portion of the camlock device will be less than a length and width of the first portion of the camlock device.

When the first and second portions of the camlock device are placed above, within, and underneath the locking and spacing apparatus, the locking and spacing apparatus is still not secured within the one or more decorative screen panels. Accordingly, the first and second portion of the camlock device are rotated in the perpendicular direction to secure the locking and spacing apparatus onto the one or more decorative screen panels. Therefore, when the first and second portions of the camlock device are fully rotated in the perpendicular direction, the locking and spacing apparatus can be secured onto the one or more decorative screen panels.

The locking and spacing apparatus can prevent the decorative screen panel from falling out of place. If one or more unforeseen events occur, or if outside forces are applied, the decorative screen panel can remain securely in place within the interconnected structure. More traditional locking mechanisms on the perimeter or edges of the decorative screen panels are not required. The locking and spacing apparatus is an efficient locking mechanism that does not require a great mount of space or area in or around the decorative screen panels.

In the interconnected structure, in one or more embodiments, each decorative screen panel can include a locking and spacing apparatus that is secured onto the respective decorative screen panel by a camlock device. The locking and spacing apparatus will be configured in direct contact with the respective decorative screen panel. Further, when the camlock device is fully rotated perpendicularly, the locking and spacing apparatus will secure the decorative screen panel in place within the interconnected structure.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure.

The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

While the foregoing is directed to embodiments of the present disclosure, other and further embodiments of the present disclosure may be devised without departing from the basic scope thereof. It is understood that various embodiments described herein may be utilized in combination with any other embodiment described, without departing from the scope contained herein. Further, the foregoing description is not intended to be exhaustive or to limit the disclosure to the precise form disclosed.

Modifications and variations are possible in light of the above teachings or may be acquired from practice of the disclosure. Certain exemplary embodiments may be identified by use of an open-ended list that includes wording to indicate that the list items are representative of the embodiments.

1. A system comprising:
one or more decorative screen panels configured at an initial position;
a locking and spacing apparatus positioned on an exterior portion of the one or more decorative screen panels, wherein a spacer within the locking and spacing apparatus is positioned to receive a locking mechanism; and
the locking mechanism positioned on the locking and spacing apparatus over the one or more decorative screen panels, wherein a first portion of the locking mechanism is positioned within the spacer of the locking and spacing apparatus, and wherein a second portion of the locking mechanism is positioned under the locking and spacing apparatus and configured to move in a perpendicular direction, wherein the second portion's movement in the perpendicular direction secures the locking mechanism within the locking and spacing apparatus.

2. The system of claim 1, wherein the spacer is positioned in a center portion of the locking and spacing apparatus.

3. The system of claim 1, wherein the first portion of the locking mechanism is positioned within the spacer and over the exterior portion of the one or more decorative screen panels.

4. The system of claim 1, wherein the second portion of the locking mechanism rotates in the perpendicular direction to secure the locking mechanism over the one or more decorative screen panels.

5. The system of claim 1, wherein the spacer includes a circular opening to receive the first portion of the locking mechanism.

6. The system of claim 1, wherein the first portion of the locking mechanism has a greater length and width then the second portion of the locking mechanism.

7. The system of claim 1, wherein first portion of the locking mechanism is configured to rotate in the perpendicular direction after being positioned within the locking and spacing apparatus.

8. A system comprising:
a decorative screen panel configured at an initial position;
a spacer configured onto the decorative screen panel, wherein the spacer is configured on an exterior portion of the decorative screen panel, wherein an center portion of the spacer includes an opening for one or more devices; and
a camlock device positioned on the spacer on the exterior portion of the decorative screen panel, wherein a first portion of the camlock device is positioned within the spacer, and wherein a second portion of the camlock device is positioned under the spacer, wherein the first and second portions of the camlock device are rotated to secure the spacer onto the decorative screen panel.

9. The system of claim 8, wherein the first portion of the camlock device is rotated in a perpendicular direction to secure the spacer onto the decorative screen panel.

10. The system of claim 8, wherein the second portion of the camlock device is rotated in a same direction as the first portion of the camlock device to secure the camlock device over the decorative screen panel.

11. The system of claim 8, wherein the first portion of the camlock device is placed in contact with the exterior portion of the decorative screen panel.

12. The system of claim 8, wherein the second portion of the camlock device is configured in a perpendicular direction to the spacer.

13. The system of claim 8, wherein the camlock device secures the decorative screen panel in between one or more corner brackets.

14. The system of claim 8, wherein the camlock device secures the decorative screen panel in between one or more frame members.

15. A method comprising:
configuring one or more decorative screen panels cat an initial position;
positioning a locking and spacing apparatus on an exterior portion of the one or more decorative screen panels, wherein a spacer within the locking and spacing apparatus is positioned to receive a locking mechanism; and
configuring the locking mechanism on the locking and spacing apparatus over the one or more decorative screen panels, wherein a first portion of the locking mechanism is positioned within the spacer of the locking and spacing apparatus, and wherein a second portion of the locking mechanism is positioned under the locking and spacing apparatus and configured to move in a perpendicular direction, wherein the second portion's movement in the perpendicular direction secures the locking mechanism within the locking and spacing apparatus.

16. The method of claim 15, further comprising:
rotating the first portion of the locking mechanism in the perpendicular direction in alignment with the second portion of the locking mechanism.

17. The method of claim 15, further comprising:
positioning the first portion of the locking mechanism over the spacer to secure the locking and spacing apparatus.

18. The method of claim 15, further comprising:
positioning the first portion of the locking mechanism in contact with an exterior portion of the one or more decorative screen panels.

19. The method of claim 15, wherein the second portion of the locking mechanism is configured under the exterior portion of the one or more decorative screen panels to secure the locking and spacing apparatus within the exterior portion of the one or more decorative screen panels.

20. The method of claim 15, wherein the spacer is secured in between the first portion of the locking mechanism and the second portion of the locking mechanism in a locked position.
